(19) United States
(12) Patent Application Publication
(10) Pub. No.: US 2012/0056107 A1
(43) Pub. Date: Mar. 8, 2012

(54) UNIFORMITY CONTROL USING ION BEAM BLOCKERS

(75) Inventors: Daniel DISTASO, Lynnfield, MA (US); Joseph C. OLSON, Beverly, MA (US); Frank SINCLAIR, Quincy, MA (US)

(73) Assignee: VARIAN SEMICONDUCTOR EQUIPMENT ASSOCIATES, INC., Gloucester, MA (US)

(21) Appl. No.: 12/877,715

(22) Filed: Sep. 8, 2010

(51) Int. Cl. G21G 1/00; G21G 5/00

(52) U.S. Cl. 250/492.3

(57) ABSTRACT

An ion beam is generated and the energy of this ion beam is changed from a first energy to a second energy through, for example, acceleration or deceleration. A portion of the ion beam is blocked after the energy is changed and the ion beam is implanted into a workpiece. A plurality of blockers may be used to block the beam. Each blocker may be attached to a drive unit configured to translate one of the blockers in a first direction.

### FIELD

This invention relates to ion implantation and, more particularly, to uniformity of an ion beam used for implantation.

### BACKGROUND

Ion implantation is a standard technique for introducing conductivity-altering impurities into a workpiece. A desired impurity material is ionized in an ion source, the ions are accelerated to form an ion beam of prescribed energy, and the ion beam is directed at the surface of the workpiece. The energetic ions in the beam penetrate into the bulk of the workpiece material and are embedded into the crystalline lattice of the workpiece material to form a region of desired conductivity.

In one instance, a ribbon ion beam is used to implant the workpiece. A ribbon ion beam cross-section has a long dimension and a short dimension. The long dimension, for example, may be referred to as a width or x-direction, though other orientations are possible. The ribbon ion beam may be formed using a parallelizing lens or may be a scanned spot beam. This ribbon ion beam is composed of ions, which usually have a positive charge, and negatively-charged electrons. The ribbon ion beam may hold together in part because it has both negative and positive particles. If the ribbon ion beam only has positively-charged particles, the beam may expand or “blow up.” Thus, the electrons may help mitigate this beam “blow up.” The ions and electrons interact with each other and their opposite charges help maintain the ribbon ion beam.

Occasionally, the ribbon ion beam may not be perfectly uniform. Mechanical trimming of the ribbon ion beam may fix any uniformity problems by blocking or trimming a portion of the ribbon ion beam. However, if the mechanical trimmer is positioned upstream of an ion beam energy adjustment unit, such as an acceleration lens or deceleration lens, or an ion beam focusing unit, such as an einzel lens, the mechanical trimming may not function effectively. FIGS. 1A-B are graphs showing current density versus x-direction in a first embodiment. In FIG. 1A, a non-uniform ribbon ion beam is illustrated with a non-uniform region 100. The objective is to mechanically remove this non-uniform region 100 to form a uniform ribbon ion beam across the x-direction as shown on the x-axis of FIG. 1A, thus giving the ribbon ion beam a uniform current density across the x-direction. If the ribbon ion beam illustrated in FIG. 1A has the non-uniform region 100 mechanically trimmed before, for example, deceleration or acceleration, the results are illustrated in FIG. 1B. As seen in FIG. 1B, a non-uniform region 101 larger than the non-uniform region 100 is formed. The current density on either side of the non-uniform region 101 is lower compared to FIG. 1A.

FIGS. 2A-C illustrate a mechanism that may cause the result illustrated in FIG. 1B. There may be two causes for the non-uniform region 101. In FIG. 2A, a simplified ribbon ion beam is illustrated with positively-charged particles 102 and negatively-charged particles 103. FIG. 2A is merely illustrative and not meant to show an actual ribbon ion beam cross-section. The non-uniform region 100 (illustrated in FIG. 2A by the area surrounded by the dotted line) includes three positively-charged particles 102 per column. The remainder of the ion beam only has two positively-charged particles 102. This extra positively-charged particle 102 results in the non-uniform region 100.

As seen in FIG. 2B, the mechanical trimming removes a positively-charged particle 102 from the non-uniform region 100. While the ion beam may not be exactly rectangular after the mechanical trimming, the ion beam now has a uniform number of positively-charged particles 102 across its width (i.e., in each column). In this particular instance, there are an equal or approximately equal number of positively-charged particles 102 and negatively-charged particles 103. This helps maintain the shape and profile of the ion beam.

As seen in FIG. 2C, the acceleration, deceleration, or focusing strips some, if not all, of the negatively-charged particles 103 from the ribbon ion beam. For example, an electrostatic lens is at a high negative potential, which repels negatively-charged particles 103. This reduces the number of negatively-charged particles 103 in the ribbon ion beam after the stripping. As seen in FIG. 2C, positively-charged particles 102 fill in the gap due to the lack of balancing negative charges and the repulsion of other positive charges (as illustrated using the arrows). So space charge actually worsens the problem. This enlarges the non-uniform region 100 of FIG. 1A into the non-uniform region 101 of FIG. 1B. While negatively-charged particles 103 may return and re-neutralize the ion beam, the non-uniform region 101 of FIG. 1B has already been formed. Removing the non-uniform region 101 after the trimming illustrated in FIG. 2A-C increases the complexity of operation.

Ribbon ion beam uniformity is one factor that affects implantation. Non-uniform ribbon ion beams may result in imprecise doping or implantation. For example, more heavily-doped stripes may be formed on the surface of a workpiece. An incorrect dose may cause yield issues if the devices are non-functioning due to the increased or decreased dose. Beam energy is yet another factor that affects implantation. Specific beam energies are needed for various devices because beam energy is related to implant depth. Incorrect beam energy may result in implants that are too shallow or too deep, also potentially affecting yield if non-functioning devices are formed. Therefore, there is a need in the art for uniformity during implantation and, more particularly, uniformity during implantation where beam energy is changed.

### SUMMARY

According to a first aspect of the invention, a method of ion implantation is provided. The method comprises generating an ion beam and mass analyzing the ion beam. The energy of the ion beam is changed from a first energy to a second energy after the mass analyzing. A portion of the ion beam is blocked after the energy is changed. The ion beam is implanted into a workpiece after the blocking.

According to a second aspect of the invention, an ion implanter is provided. The ion implanter comprises an ion source that generates an ion beam. An ion beam energy adjustment unit is disposed downstream of the ion source. An end station is disposed downstream of the ion beam energy adjustment unit. An ion beam blocker unit is positioned between the ion beam energy adjustment unit and the end station. The ion beam blocker unit is configured to block a portion of the ion beam.

According to a third aspect of the invention, an ion implanter is provided. The ion implanter comprises a platen and a plurality of blockers upstream of the platen. An ion beam energy adjustment unit is upstream of the plurality of blockers. The ion implanter also comprises a plurality of drive units. Each of the drive units is connected to one of the plurality of blockers and configured to translate one of the blockers in a first direction.

### BRIEF DESCRIPTION OF THE DRAWINGS

For a better understanding of the present disclosure, reference is made to the accompanying drawings, which are incorporated herein by reference and in which:

FIGS. 1A-B are graphs showing current density versus x-direction in a first embodiment;

FIGS. 2A-C illustrate a mechanism that may cause the result illustrated in FIG. 1B;

FIG. 3 is a block diagram of a beam-line ion implanter;

FIG. 4 is a side cross-sectional view of an ion beam blocker unit;

FIG. 5 is a front perspective view of the ion beam blocker unit illustrated in FIG. 4;

FIG. 6 is a front perspective view of a second embodiment of a blocker; and

FIGS. 7A-B are graphs showing current density versus x-direction in a second embodiment.

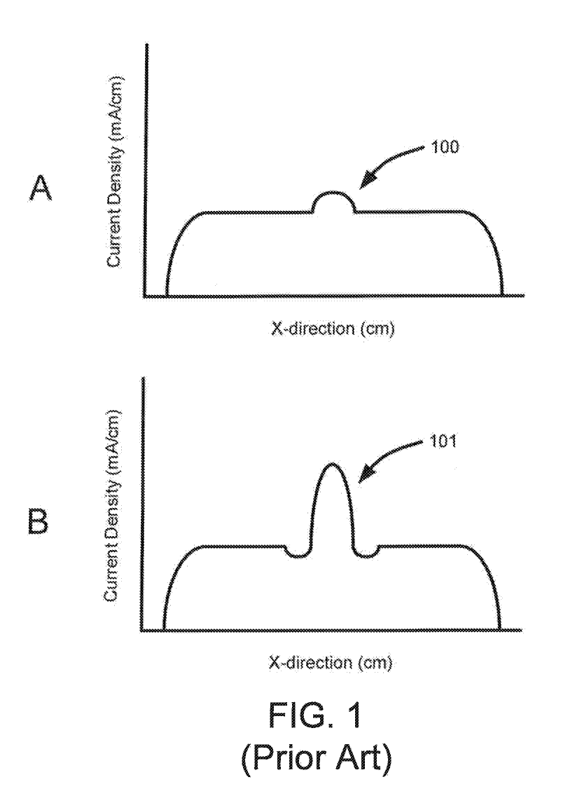

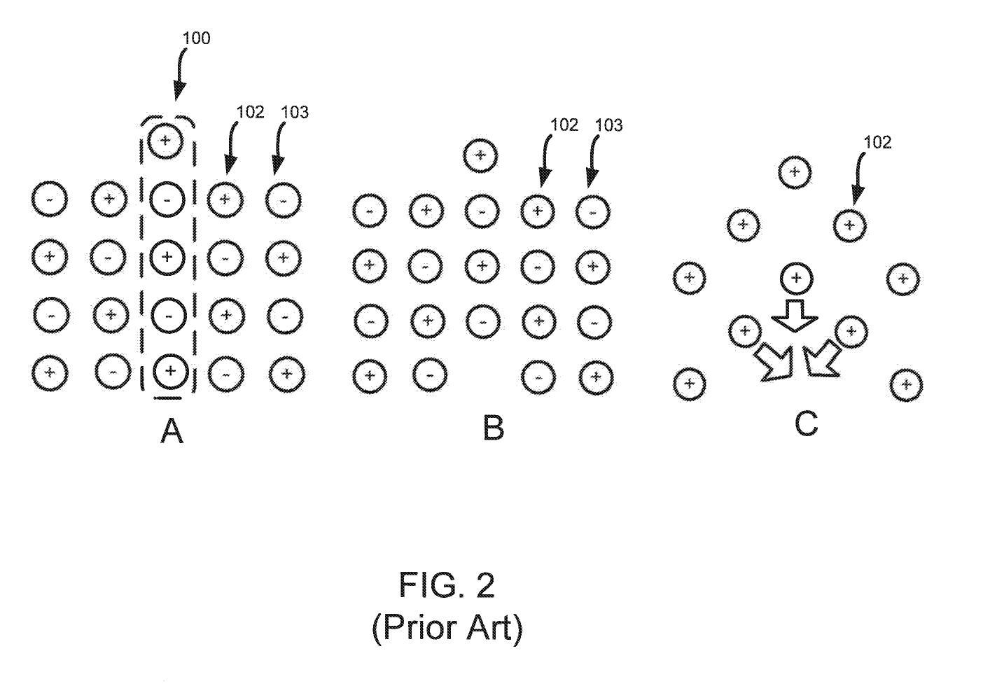

### DETAILED DESCRIPTION

These apparatus and method embodiments are described herein in connection with an ion implanter. However, the various embodiments can be used with other systems and processes involved in semiconductor manufacturing or other systems that use charged particles. While a semiconductor wafer is specifically mentioned, other workpieces such as solar cells, light-emitting diodes (LEDs), flat panels, or other workpieces known to those skilled in the art also may benefit. Furthermore, while a ribbon ion beam is disclosed, the embodiments disclosed herein also may be applicable to a spot beam or a scanned spot beam. Thus, the invention is not limited to the specific embodiments described below.

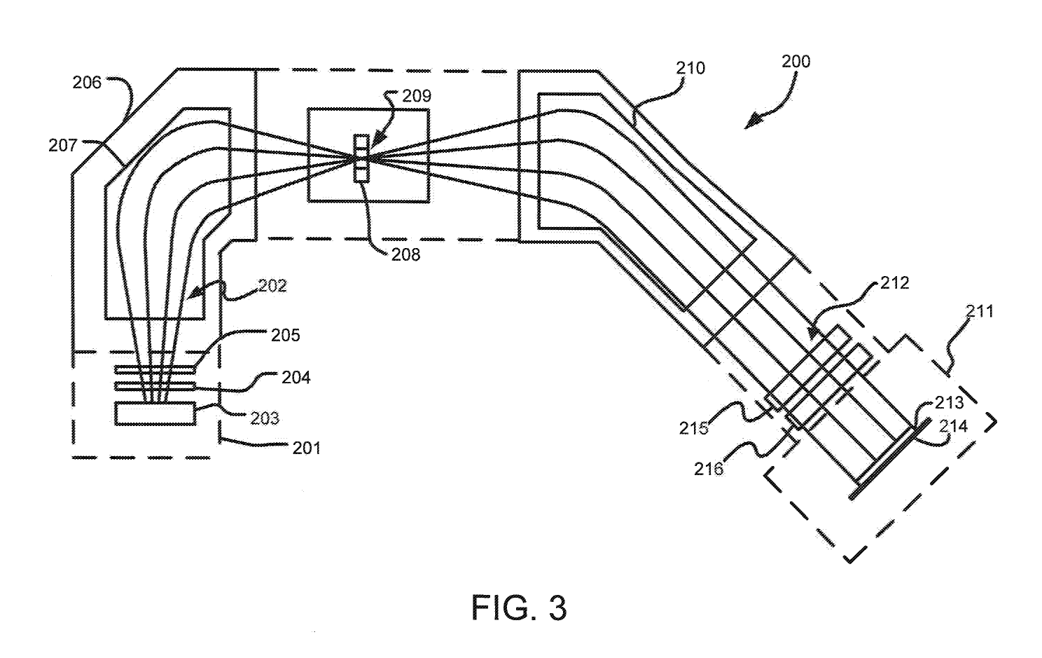

FIG. 3 is a block diagram of a beam-line ion implanter 200. Those skilled in the art will recognize that the beam-line ion implanter 200 is only one of many examples of beam-line ion implanters that can produce ions. Thus, the embodiments disclosed herein are not limited solely to the beam-line ion implanter 200 of FIG. 3.

In general, the beam-line ion implanter 200 includes an ion source 201 to generate ions that form an ion beam 202. The ion source 201 may include an ion chamber 203. A gas is supplied to the ion chamber 203 where the gas is ionized. This gas may be or may include or contain, in some embodiments, a p-type dopant, an n-type dopant, carbon, hydrogen, a noble gas, a molecular compound, or some other species known to those skilled in the art. The ions thus generated are extracted from the ion chamber 203 to form the ion beam 202. The ion beam 202 passes through a suppression electrode 204 and ground electrode 205 to the mass analyzer 206. The mass analyzer 206 includes a resolving magnet 207 and a masking electrode 208 having a resolving aperture 209. The resolving magnet 207 deflects ions in the ion beam 202 such that ions of a desired ion species pass through the resolving aperture 209. Undesired ion species do not pass through the resolving aperture 209, but are blocked by the masking electrode 208.

Ions of the desired ion species pass through the resolving aperture 209 to the angle corrector magnet 210. The angle corrector magnet 210 deflects ions of the desired ion species and converts the ion beam from a diverging ion beam to ribbon ion beam 212, which has substantially parallel ion trajectories. The beam-line ion implanter 200 may further include an ion beam energy adjustment unit 215. This ion beam energy adjustment unit 215 may be, for example, an acceleration lens or deceleration lens that changes the energy of the ion beam from a first energy to a second energy. Such an ion beam energy adjustment unit may have a series of electrodes at different electrostatic potentials to either increase or decrease the energy of the ribbon ion beam 212. After the ion beam energy adjustment unit 215 is an ion beam blocker unit 216. The ion beam blocker unit 216 blocks a portion of the ribbon ion beam 212. While this ion beam energy adjustment unit 215 is illustrated downstream of the angle corrector magnet 210, it may be elsewhere such as upstream of the mass analyzer 206.

An end station 211 supports one or more workpieces, such as workpiece 213, in the path of ribbon ion beam 212 such that ions of the desired species are implanted into workpiece 213. The workpiece 213 may be, for example, a semiconductor wafer. The end station 211 may include a platen 214 to support one or more workpieces 213. The end station 211 also may include a scanner (not shown) for moving the workpiece 213 perpendicular to the long dimension of the ribbon ion beam 212 cross-section, thereby distributing ions over the entire surface of workpiece 213. It will be understood to those skilled in the art that the entire path traversed by the ion beam is evacuated during ion implantation. The ion implanter 200 may include additional components known to those skilled in the art and may incorporate hot or cold implantation of ions in some embodiments.

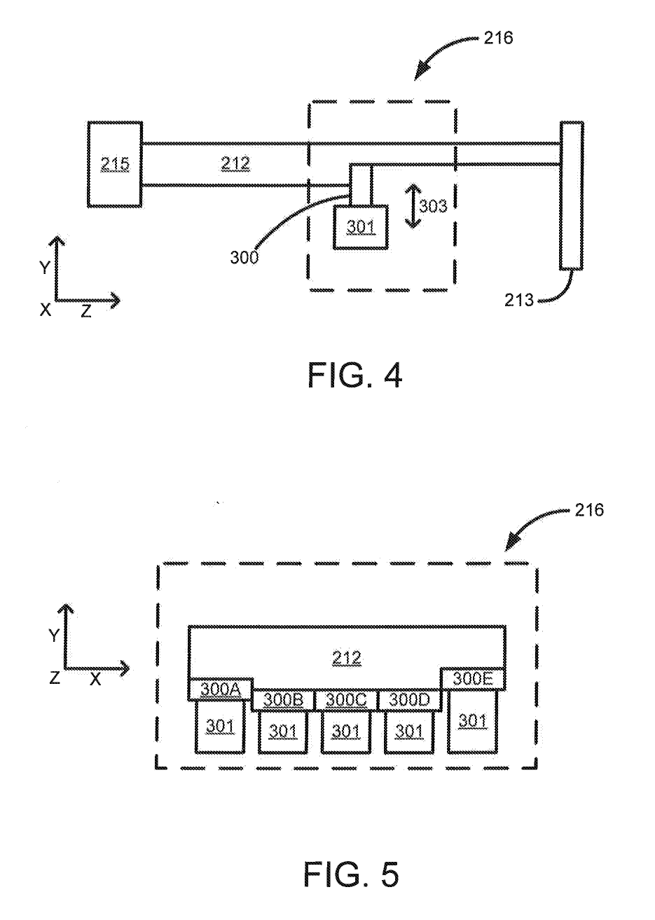

FIG. 4 is a side cross-sectional view of an ion beam blocker unit. The ion beam blocker unit 216 (shown by the dotted line) is downstream of the ion beam energy adjustment unit 215 if the ribbon ion beam 212 is going in the z-direction to implant the workpiece 213. The ion beam blocker unit 216 includes at least one blocker 300. Each blocker 300 is connected to a drive unit 301 to translate the blocker 300 in the y-direction illustrated by arrow 303. The distance the blocker 300 is translated affects how much of the ribbon ion beam 212 is blocked or trimmed. The drive unit 301 may be a piezo-electric drive or some other system known to those skilled in the art. The blocker 300 may be fabricated of graphite or some other material that does not contaminate the ribbon ion beam 212.

As seen in FIG. 4, the ion beam blocker unit 216 is downstream of the ion beam energy adjustment unit 215. Thus, the ion beam blocker unit 216 is positioned after the final location the electrons may be stripped from the ribbon ion beam 212. After the ribbon ion beam 212 passes through the ion beam energy adjustment unit 215, electrons may return to the ribbon ion beam 212 to balance charges.

FIG. 5 is a front perspective view of the ion beam blocker unit illustrated in FIG. 4. FIG. 5 still illustrates the ribbon ion beam 212 going in the z-direction, but now the z-direction comes out of the page. Five blockers 300A-E are illustrated in FIG. 5, but other configurations may be used and this embodiment is not solely limited to five. The blockers 300A-E may be arranged in an array. The drive units 301 translate the blockers 300A-E in the y-direction. Each blocker 300A-E may be individually translated. Thus, blocker 300E blocks or trims more of the ribbon ion beam 212 than blocker 300A, which blocks or trims more of the ribbon ion beam 212 than blockers 300B-D. The individual pattern of the blockers 300A-E depends on the non-uniformity of the ribbon ion beam 212 or how much of the ribbon ion beam 212 needs to be blocked or trimmed. The blockers 300A-E also may be translated out of the path of the ribbon ion beam 212. It may be desirable to have a ribbon ion beam 212 where the vertical integration (such as the y-direction) of the beam is the same throughout the entire ribbon ion beam 212. A controller may be used to determine the placement or translation of the individual blockers 300A-E to make the ribbon ion beam 212 more uniform. This controller may be connected to a measurement device that can detect uniformity, profile, or current of the ribbon ion beam 212.

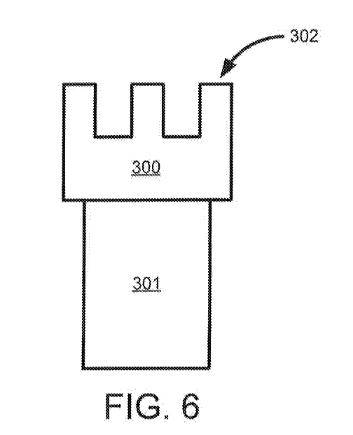

While rectangular blockers 300A-E are illustrated, other shapes are possible. For example, each blocker 300A-E may have multiple crenellations or teeth that can block or trim the ribbon ion beam 212. Other patterns or shapes also may be used. FIG. 6 is a front perspective view of a second embodiment of a blocker. The blocker 300 includes multiple teeth 302. Thus, each blocker 300 can block multiple portions of the ion beam.

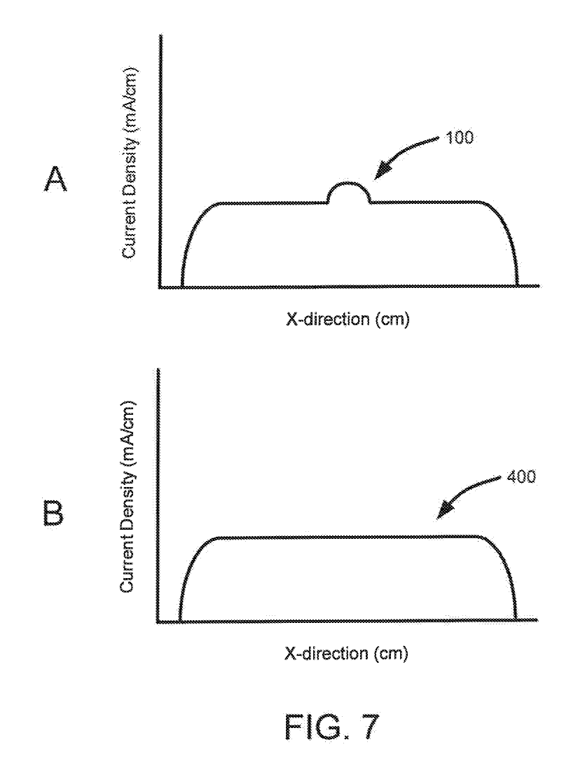

FIGS. 7A-B are graphs showing current density versus x-direction in a second embodiment. In FIG. 7A, a non-uniform ribbon ion beam is illustrated with a non-uniform region 100. However, by placing a ion beam blocker unit downstream of the last location that electrons may be stripped from the beam, such as at the ion beam energy adjustment unit 215 or a focusing unit, a uniform ribbon ion beam 400 may be formed, as seen in FIG. 7B. Due to the presence of the electrons in the ion beam, the ions do not fill in the gap created by the ion beam blocker unit. So the ion beam blocker unit 216 of FIG. 4 may be used to make a beam with a first, non-uniform beam current profile have a second, uniform beam current profile.

In one particular embodiment, the ion beam blocker unit 216 is positioned directly downstream of the ion beam energy adjustment unit 215 and may be connected to the exit of the ion beam energy adjustment unit 215. In another embodiment, the ion beam blocker unit 216 is positioned at the entrance to the end station 211. If the ion beam blocker unit 216 is positioned in front of or upstream of the workpiece without a region between that strips electrons, a uniform beam current profile may be obtained. The ion beam blocker unit 216 may be positioned near the workpiece or such that the space between the ion beam blocker unit 216 and workpiece is essentially free of strong electric or magnetic fields.

The ion beam blocker unit 216 does not affect the angles of the ribbon ion beam 212 or the beamlets within the ribbon ion beam 212. Instead, the angles may be affected by other electrodes or magnets. Thus, the uniformity adjustment with the ion beam blocker unit 216 and any angle adjustment with electrodes or magnets may be decoupled. Furthermore, the energy adjustment using the ion beam energy adjustment unit 215 also may be decoupled. Thus, the uniformity, angles, and energy of the ribbon ion beam 212 may be optimized without any unintended or undesired interaction.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of ion implantation comprising:
generating an ion beam;
mass analyzing said ion beam;
changing an energy of said ion beam from a first energy to a second energy after said mass analyzing;
blocking a portion of said ion beam after said changing; and
implanting said ion beam into a workpiece after said blocking.

2. The method of claim 1, wherein said ion beam is a ribbon ion beam with a long dimension and a short dimension.

3. The method of claim 2, wherein said ribbon ion beam has an initial beam current profile, wherein said blocking comprises measuring said initial beam current profile and blocking a portion of said ribbon ion beam so that said ribbon ion beam has a second beam current profile different from said first beam current profile.

4. The method of claim 3, wherein said second beam current profile is uniform across said long dimension of said ribbon ion beam.

5. The method of claim 1, wherein said first energy is larger than said second energy.

6. The method of claim 1, wherein said second energy is larger than said first energy.

7. An ion implanter comprising:
an ion source that generates an ion beam;
an ion beam energy adjustment unit downstream of said ion source;
an end station downstream of said ion beam energy adjustment unit; and
an ion beam blocker unit positioned between said ion beam energy adjustment unit and said end station, said ion beam blocker unit configured to block a portion of said ion beam.

8. The ion implanter of claim 7, wherein said ion beam energy adjustment unit comprises a deceleration lens.

9. The ion implanter of claim 7, wherein said ion beam energy adjustment unit comprises an acceleration lens.

10. The ion implanter of claim 7, wherein the ion beam blocker unit comprises a plurality of blockers.

11. The ion implanter of claim 10, wherein a drive unit is connected to each of said blockers, and wherein each of said drive units is configured to translate one of said blockers in a first direction.

12. The ion implanter of claim 7, further comprising a controller connected to said ion beam blocker unit, said controller configured to adjust said portion of said ion beam blocked by said ion beam blocker unit.

13. The ion implanter of claim 7, further comprising an angle corrector magnet upstream of said ion beam energy adjustment unit.

14. An ion implanter comprising:
a platen
a plurality of blockers upstream of said platen;
an ion beam energy adjustment unit upstream of said plurality of blockers; and
a plurality of drive units, each of said drive units connected to one of said plurality of blockers and configured to translate one of said blockers in a first direction.

15. The ion implanter of claim 14, wherein said ion beam energy adjustment unit comprises a deceleration lens.

16. The ion implanter of claim 14, wherein said ion beam energy adjustment unit comprises an acceleration lens.

17. The ion implanter of claim 14, wherein said plurality of blockers are configured to translate in and out of a path of an ion beam along said first direction.

18. The ion implanter of claim 14, further comprising a controller connected to said plurality of drive units, said controller configured to adjust each of said plurality of blockers in said first direction.

19. The ion implanter of claim 18, wherein each of said plurality of blockers is adjusted individually by said controller.

20. The ion implanter of claim 14, further comprising an ion source, and wherein said ion beam energy adjustment unit is downstream of said ion source.
